(19) United States
(12) Patent Application Publication
(10) Pub. No.: US 2010/0283765 A1
(43) Pub. Date: Nov. 11, 2010

(54) DISPLAY DEVICE HAVING OPTICAL SENSORS

(75) Inventors: Toshimitsu Gotoh, Osaka (JP); Akizumi Fujioka, Osaka (JP); Akinori Kubota, Osaka (JP); Kei Oyobe, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/811,138

(22) PCT Filed: Feb. 16, 2009
(86) PCT No.: PCT/JP2009/052478

§ 371 Date: Jun. 29, 2010

(30) Foreign Application Priority Data
Mar. 3, 2008 (JP) 2008-052162

(51) Int. Cl. G06F 3/042

(52) U.S. Cl. 345/175

(57) ABSTRACT

A liquid crystal panel with built-in sensors 11 includes, in a pixel array 17, a plurality of pixel circuits 1 and a plurality of optical sensors 2 which are arranged two-dimensionally. Infrared light transmitting filters 3 that allow infrared light to pass therethrough and cut off visible light are respectively provided in paths of light entering the optical sensors 2. Accordingly, an image obtained by the optical sensors 2 is prevented from being influenced by visible light included in outside light or backlight light and thus a touch position is detected with high accuracy, based on an image that is not influenced by visible light included in a large amount in outside light or backlight light. Instead of the infrared light transmitting filters 3, a light-shielding film having the same property 3 may be used.

### TECHNICAL FIELD

The present invention relates to a display device and more particularly to a display device having a plurality of optical sensors provided in a display panel.

### BACKGROUND ART

In recent years, electronic devices that can be operated by touching a screen with a finger, a pen, or the like, have proliferated. In addition, for a method of detecting a touch position on a display screen, a method is known in which a plurality of optical sensors are provided in a display panel and a shadow image which is created when a finger or the like approaches a screen is detected using the optical sensors. In the method of detecting a shadow image, when the illumination of outside light is low (the surroundings are dark), it becomes difficult to distinguish between a shadow image and a background in an image obtained by the optical sensors and accordingly a touch position may not be able to be detected properly. In view of the above, for display devices including a backlight, a method is also known in which a reflection image which is created when backlight light hits a finger is detected using optical sensors.

A display device having a plurality of optical sensors provided in a display panel is described in, for example, Patent Document 1. In addition, Patent Document 2 describes a liquid crystal panel including, as shown in FIG. 17, a pixel portion PP and an infrared detecting portion ISP. The pixel portion PP is provided with a first TFT (T1), a transparent electrode TE, a reflecting electrode RE, and the like, and the infrared detecting portion ISP is provided with a capacitor C, a second TFT (T2), and the like. The reflecting electrode RE is provided with a transmission window W1 for allowing the transparent electrode TE to be exposed therefrom and an opening window W2 for allowing a pyroelectric thin film PE1 in the capacitor C to be exposed therefrom. The opening window W2 is provided to facilitate the application of infrared radiation which is intentionally provided by a user from outside the liquid crystal panel, to the pyroelectric thin film PE1.

[Patent Document 1] Japanese Laid-Open Patent Publication No. 2007-102154

[Patent Document 2] Japanese Laid-Open Patent Publication No. 2004-321685

### DISCLOSURE OF THE INVENTION

### Problems to be Solved by the Invention

However, a conventional display device with optical sensors may have difficulty in recognizing a finger in some operating environments and thus may not be able to properly detect a touch position. For example, the case will be considered in which, as shown in FIG. 18, a liquid crystal display device including a liquid crystal panel with optical sensors 91 and a backlight 92 operates under two fluorescent lamps 93 and 94 which are turned on. In this case, when a finger 95 is placed on the liquid crystal panel with optical sensors 91, an image including, as shown in FIG. 19, a shadow image of the finger created by the fluorescent lamp 93 and a shadow image of the finger created by the fluorescent lamp 94 is obtained. When there are a large number of fluorescent lamps or when there are light sources other than fluorescent lamps, a larger number of finger images are included in an image obtained by the optical sensors. However, since it is difficult to properly recognize the finger from all images obtained by the optical sensors, a touch position may not be properly detected from the image shown in FIG. 19. As such, the conventional display device with optical sensors has a problem that, since an image obtained by the optical sensors is influenced by outside light or backlight light, the detection accuracy for a touch position decreases.

An object of the present invention is therefore to provide a display device with optical sensors that can detect a touch position with high accuracy without being influenced by outside light or backlight light.

### Means for Solving the Problems

According to a first aspect of the present invention, there is provided a display device including a plurality of optical sensors, the display device including: a plurality of pixel circuits arranged two-dimensionally; a plurality of optical sensors arranged two-dimensionally in a same plane as the pixel circuits; and a filter portion that is provided in path of light entering the optical sensor and that allows infrared light to pass therethrough and cuts off visible light.

According to a second aspect of the present invention, in the first aspect of the present invention, the display device further includes a color filter of a plurality of colors, the pixel circuits and the optical sensors are formed of polysilicon, and the filter portion is formed within a red color filter of the color filter.

According to a third aspect of the present invention, in the second aspect of the present invention, the display device further includes a light-shielding film having openings for the respective pixel circuits, and the filter portion is arranged in a position within the red color filter and adjacent to the light-shielding film.

According to a fourth aspect of the present invention, in the first aspect of the present invention, the display device further includes a color filter of a plurality of colors, the pixel circuits and the optical sensors are formed of polysilicon, and the filter portion is formed separately from the color filter and is arranged in a position in which the filter portion overlaps a red color filter of the color filter when viewed in a direction perpendicular to the filter portion.

According to a fifth aspect of the present invention, in the fourth aspect of the present invention, the display device further includes a light-shielding film having openings for the respective pixel circuits, and the filter portion is arranged in a position in which the filter portion overlaps the red color filter when viewed in the direction perpendicular to the filter portion and which is adjacent to the light-shielding film.

According to a sixth aspect of the present invention, in the first aspect of the present invention, the filter portion is a resin filter.

According to a seventh aspect of the present invention, in the first aspect of the present invention, the filter portion has a function of polarizing entered light.

According to an eighth aspect of the present invention, in the first aspect of the present invention, a light-shielding film having openings for the respective pixel circuits is provided as the filter portion, and the optical sensor is arranged in a position in which the optical sensor overlaps the light-shielding film when viewed in a direction perpendicular to the pixel circuits.

### EFFECTS OF THE INVENTION

According to the first aspect of the present invention, since a filter portion that allows infrared light to pass therethrough and cuts off visible light is provided in path of light entering the optical sensor, an image obtained by the optical sensors is not influenced by visible light included in outside light which does not include infrared light (e.g., light from a fluorescent lamp and the like), or included in backlight light reflected off an object present in the vicinity of the display surface. Accordingly, a touch position can be detected with high accuracy, based on an image that is not influenced by visible light included in a large amount in outside light or backlight light.

According to the second aspect of the present invention, by forming the filter portion in the color filter, the configuration of the device can be simplified. In addition, the light reception sensitivity of the optical sensors formed of polysilicon is lower for red light than for green light and blue light. Therefore, by forming the filter portion within the red color filter, even when visible light enters an optical sensor in an oblique direction without passing through a filter portion, the influence of the entered visible light on an image obtained by the optical sensors is reduced, enabling to detect a touch position with high accuracy.

According to the third aspect of the present invention, by arranging the filter portion in a position within a red color filter and adjacent to the light-shielding film that cuts off visible light, even when visible light enters an optical sensor in an oblique direction without passing through a filter portion, the influence of the entered visible light on an image obtained by the optical sensors is further reduced, enabling to detect a touch position with higher accuracy.

According to the fourth aspect of the present invention, by forming the filter portion and the color filter separately, the filter portion can be implemented in various forms. In addition, the light reception sensitivity of the optical sensors formed of polysilicon is lower for red light than for green light and blue light. Thus, by arranging the filter portion in a position in which the filter portion overlaps a red color filter when viewed in a direction perpendicular to the filter portion, even when visible light enters an optical sensor in an oblique direction without passing through a filter portion, the influence of the entered visible light on an image obtained by the optical sensors is reduced, enabling to detect a touch position with high accuracy.

According to the fifth aspect of the present invention, by arranging the filter portion in a position in which the filter portion overlaps a red color filter when viewed in a direction perpendicular to the filter portion and which is adjacent to the light-shielding film that cuts off visible light, even when visible light enters an optical sensor in an oblique direction without passing through a filter portion, the influence of the entered visible light on an image obtained by the optical sensors is further reduced, enabling to detect a touch position with higher accuracy.

According to the sixth aspect of the present invention, the filter portion that allows infrared light to pass therethrough and cuts off visible light can be easily formed using a resin filter.

According to the seventh aspect of the present invention, when a polarizing plate is provided on the display surface side of a display panel including pixel circuits and optical sensors, by using, as the filter portion, polarizing filter having the function of polarizing entered light in a direction orthogonal to a polarization axis of the polarizing plate, the filter portion that allows infrared light to pass therethrough and cuts off visible light can be easily formed.

According to the eighth aspect of the present invention, by forming, by a light-shielding film, the filter portion that allows infrared light to pass therethrough and cuts off visible light, the configuration of the device can be simplified and the aperture ratio can be increased.

### BRIEF DESCRIPTION OF THE DRAWINGS

FIG. 1 is a block diagram showing a configuration of a liquid crystal display device according to a first embodiment of the present invention.

FIG. 2 is a block diagram showing a detailed configuration of a liquid crystal panel of the device shown in FIG. 1.

FIG. 3 is a timing chart for the device shown in FIG. 1.

FIG. 4 is a view showing a cross section of the liquid crystal panel and an arrangement position of a backlight of the device shown in FIG. 1.

FIG. 5 is a layout diagram of the liquid crystal panel of the device shown in FIG. 1.

FIG. 6 is a cross-sectional view of the liquid crystal panel of the device shown in FIG. 1.

FIG. 7 is another layout diagram of the liquid crystal panel of the device shown in FIG. 1.

FIG. 8A is a diagram showing the principle of a method of detecting a shadow image in the device shown in FIG. 1.

FIG. 8B is a diagram showing the principle of a method of detecting a reflection image in the device shown in FIG. 1.

FIG. 9A is a view showing an example of a scanned image obtained by the device shown in FIG. 1.

FIG. 9B is a view showing another example of the scanned image obtained by the device shown in FIG. 1.

FIG. 10A is a cross-sectional view of a liquid crystal panel of a liquid crystal display device according to a variant of the present invention.

FIG. 10B is a cross-sectional view of a liquid crystal panel of a liquid crystal display device according to a variant of the present invention.

FIG. 10C is a cross-sectional view of a liquid crystal panel of a liquid crystal display device according to a variant of the present invention.

FIG. 11 is a block diagram showing a configuration of a liquid crystal display device according to a second embodiment of the present invention.

FIG. 12 is a view showing a cross section of a liquid crystal panel and an arrangement position of a backlight of the device shown in FIG. 11.

FIG. 13 is a layout diagram of the liquid crystal panel of the device shown in FIG. 11.

FIG. 14 is a cross-sectional view of the liquid crystal panel of the device shown in FIG. 11.

FIG. 15A is a block diagram showing a configuration of a liquid crystal display device according to a variant of the present invention.

FIG. 15B is a block diagram showing a configuration of a liquid crystal display device according to a variant of the present invention.

FIG. 16 is a view showing an example of a scanned image obtained by a conventional liquid crystal display device with optical sensors.

FIG. 17 is a cross-sectional view of a conventional liquid crystal panel having an infrared detecting portion.

FIG. 18 is a diagram showing an example of an operating environment of a liquid crystal display device with optical sensors.

FIG. 19 is a view showing an example of a scanned image obtained by the conventional liquid crystal display device with optical sensors.

### DESCRIPTION OF REFERENCE NUMERALS

1 Pixel circuit
2 Optical sensor
3 Infrared light transmitting filter
4 White LED
5 Infrared LED
6 Infrared light transmitting and light-shielding film
10 and 60 Liquid crystal display device
11 and 61 Liquid crystal panel with built-in sensors
12 Display data processing unit
13 A/D converter
14 Sensor data processing unit
15 and 18 Backlight
16 Panel drive circuit
17 and 62 Pixel array
24 Photodiode
41 Glass substrate
42 Liquid crystal layer
43 Light-shielding film
44 Color filter
51 Outside light
52 Backlight light
53 Object

### BEST MODE FOR CARRYING OUT THE INVENTION

### First Embodiment

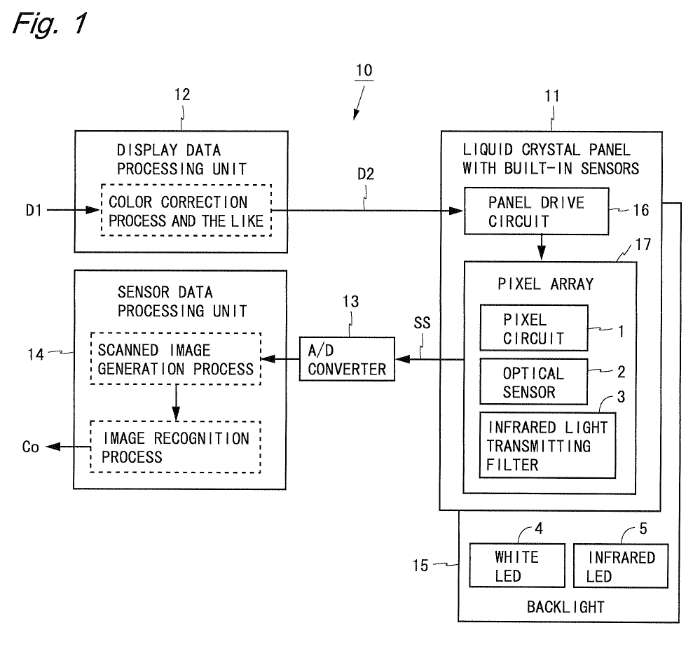

FIG. 1 is a block diagram showing a configuration of a liquid crystal display device according to a first embodiment of the present invention. A liquid crystal display device 10 shown in FIG. 1 includes a liquid crystal panel with built-in sensors 11, a display data processing unit 12, an A/D converter 13, a sensor data processing unit 14, and a backlight 15. The liquid crystal panel with built-in sensors 11 (hereinafter, referred to as the liquid crystal panel 11) includes a panel drive circuit 16 and a pixel array 17. The pixel array 17 includes a plurality of pixel circuits 1 and a plurality of optical sensors 2 which are arranged two-dimensionally. Each optical sensor 2 is provided with an infrared light transmitting filter 3 that allows infrared light to pass therethrough and cuts off (absorbs) visible light.

Display data D1 is inputted to the liquid crystal display device 10 from an external source. The display data processing unit 12 performs, if necessary, a color correction process, a frame rate conversion process, and the like, on the display data D1 and outputs display data D2. The panel drive circuit 16 writes voltages according to the display data D2 into the pixel circuits 1. Accordingly, an image based on the display data D2 is displayed on the liquid crystal panel 11.

The backlight 15 irradiates a back surface of the liquid crystal panel 11 with light (backlight light), based on a power supply voltage supplied from a backlight power supply circuit (not shown). Any type of the backlight 15 can be used but the backlight is preferably one that emits both visible light and infrared light. In the following, it is assumed that the backlight 15 includes white LEDs (Light Emitting Diodes) 4 that emit white light and infrared LEDs 5 that emit infrared light.

The panel drive circuit 16 performs the operation of reading a voltage according to the amount of received light from each optical sensor 2, in addition to the operation of writing a voltage into each pixel circuit 1. Output signals from the optical sensors 2 are outputted external to the liquid crystal panel 11 as sensor output signals SS. The A/D converter 13 converts the analog sensor output signals SS to digital signals. The sensor data processing unit 14 generates a digital image (hereinafter, referred to as a scanned image), based on the digital signals outputted from the A/D converter 13. The scanned image may include an image of a matter to be detected (e.g., a finger, a pen, or the like; hereinafter, referred to as an object) which is present in the vicinity of the front surface of the liquid crystal panel 11. The sensor data processing unit 14 performs an image recognition process for detecting an object, on the scanned image to determine an object position in the scanned image and outputs coordinate data Co representing a touch position.

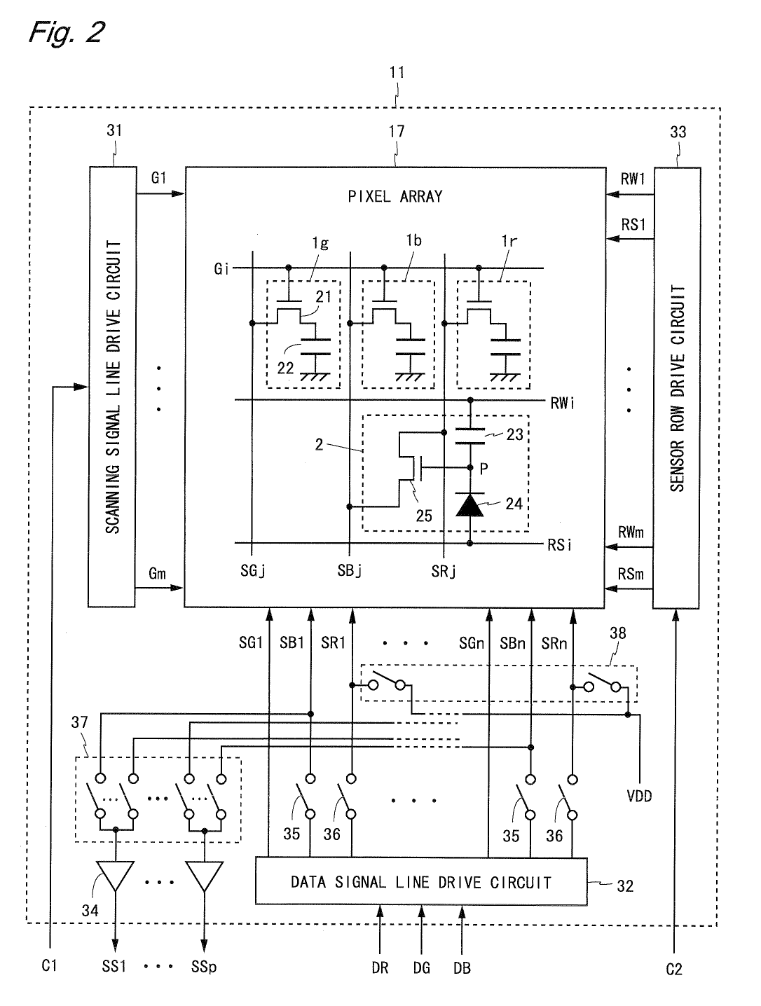

FIG. 2 is a block diagram showing a detailed configuration of the liquid crystal panel 11. As shown in FIG. 2, the pixel array 17 includes m scanning signal lines G1 to Gm; 3n data signal lines SR1 to SRn, SG1 to SGn, and SB1 to SBn; and (m×3n) pixel circuits 1. In addition to them, the pixel array 17 includes (m×n) optical sensors 2; m sensor read lines RW1 to RWm; and m sensor reset lines RS1 to RSm. The liquid crystal panel 11 is formed using polysilicon.

The scanning signal lines G1 to Gm are arranged parallel to one another. The data signal lines SR1 to SRn, SG1 to SGn, and SB1 to SBn are arranged parallel to one another so as to vertically intersect the scanning signal lines G1 to Gm. The sensor read lines RW1 to RWm and the sensor reset lines RS1 to RSm are arranged parallel to the scanning signal lines G1 to Gm.

The pixel circuits 1 are respectively provided near intersections of the scanning signal lines G1 to Gm and the data signal lines SR1 to SRn, SG1 to SGn, and SB1 to SBn. The pixel circuits 1 as a whole are arranged two-dimensionally such that m pixel circuits 1 are arranged in a column direction (a vertical direction in FIG. 2) and 3n pixel circuits 1 are arranged in a row direction (a horizontal direction in FIG. 2). The pixel circuits 1 are classified into R pixel circuits 1r, G pixel circuits 1g, and B pixel circuits 1b, depending on the color of a color filter provided. The three types of pixel circuits are arranged side by side in the row direction in order of G, B, and R and three pixel circuits form one pixel.

Each pixel circuit 1 includes a TFT (Thin Film Transistor) 21 and a liquid crystal capacitance 22. A gate terminal of the TFT 21 is connected to a corresponding scanning signal line G1 (i is an integer between 1 and m inclusive), a source terminal is connected to a corresponding one of the data signal lines SRj, SGj, and SBj (j is an integer between 1 and n inclusive), and a drain terminal is connected to one electrode of the liquid crystal capacitance 22. To the other electrode of the liquid crystal capacitance 22 is applied a common electrode voltage. The data signal lines SR1 to SRn connected to the R pixel circuits 1r are hereinafter referred to as the R data signal lines and the data signal lines SB1 to SBn connected to the B pixel circuits 1b as the B data signal lines. Note that the pixel circuits 1 may include an auxiliary capacitance.

The light transmittance of a pixel circuit 1 (the luminance of a sub-pixel) is determined by a voltage written into the pixel circuit 1. To write a certain voltage into a pixel circuit 1 connected to a scanning signal line G1 and a data signal line SXj (X is any one of R, G, and B), a high-level voltage (a voltage that places a TFT 21 in an on state) is applied to the scanning signal line G1 and a voltage to be written is applied to the data signal line SXj. By writing a voltage according to display data D2 into the pixel circuit 1, the luminance of the sub-pixel can be set to a desired level.

Each optical sensor 2 includes a capacitor 23, a photodiode 24, and a sensor preamplifier 25, and is provided for each pixel. One electrode of the capacitor 23 is connected to a cathode terminal of the photodiode 24 (hereinafter, this connecting point is referred to as the node P). The other electrode of the capacitor 23 is connected to a corresponding sensor read line RWi and an anode terminal of the photodiode 24 is connected to a corresponding sensor reset line RSi. The sensor preamplifier 25 is configured by a TFT having a gate terminal connected to the node P and having a drain terminal connected to a corresponding R data signal line SRj and having a source terminal connected to a corresponding B data signal line SBj.

To detect the amount of light by an optical sensor 2 connected to a sensor read line RWi, a B data signal line SBj, and the like, a predetermined voltage is applied to the sensor read line RWi and a sensor reset line RSi and a power supply voltage VDD is applied to an R data signal line SRj. After the predetermined voltage is applied to the sensor read line RWi and the sensor reset line RSi, when light enters a photodiode 24, a current according to the amount of entered light flows through the photodiode 24 and accordingly the voltage at a node P decreases by an amount corresponding to the amount of current having flown through. By applying, at this timing, a high voltage to the sensor read line RWi to bring up the voltage at the node P and set the gate voltage of a sensor preamplifier 25 to a threshold value or more and then applying a power supply voltage VDD to the R data signal line SRj, the voltage at the node P is amplified by the sensor preamplifier 25 and thus the amplified voltage is outputted to the B data signal line SBj. Therefore, based on the voltage of the B data signal line SBj, the amount of light detected by the optical sensor 2 can be determined.

Around the pixel array 17 are provided a scanning signal line drive circuit 31, a data signal line drive circuit 32, a sensor row drive circuit 33, p sensor output amplifiers 34 (p is an integer between 1 and n inclusive), and a plurality of switches 35 to 38. The scanning signal line drive circuit 31, the data signal line drive circuit 32, and the sensor row drive circuit 33 correspond to the panel drive circuit 16 in FIG. 1.

The data signal line drive circuit 32 has 3n output terminals for the respective 3n data signal lines. The switches 35 are respectively provided between the B data signal lines SB1 to SBn and n output terminals provided for the respective B data signal lines SB1 to SBn, and the switches 36 are respectively provided between the R data signal lines SR1 to SRn and n output terminals provided for the respective R data signal lines SR1 to SRn. The B data signal lines SB1 to SBn are divided into groups, each including p B data signal lines. One switch 37 is provided between a k-th B data signal line in each group (k is an integer between 1 and p inclusive) and an input terminal of a k-th sensor output amplifier 34. One switch 38 is provided between each of the R data signal lines SR1 to SRn and a power supply voltage VDD. The respective numbers of the switches 35 to 38 included in FIG. 2 are all n.

In the liquid crystal display device 10, one frame time is divided into a display period during which signals (voltage signals according to display data) are written into the pixel circuits and a sensing period during which signals (voltage signals according to the amounts of received light) are read from the optical sensors. The circuits shown in FIG. 2 perform operations that differ between the display period and the sensing period. During the display period, the switches 35 and 36 are placed in an on state and the switches 37 and 38 are placed in an off state. On the other hand, during the sensing period, the switches 35 and 36 are placed in an off state, the switches 38 are placed in an on state, and the switches 37 are placed in an on state in a time-division manner such that the B data signal lines SB1 to SBn are connected in turn to the input terminals of the sensor output amplifiers 34 on a group-by-group basis.

During the display period, the scanning signal line drive circuit 31 and the data signal line drive circuit 32 operate. The scanning signal line drive circuit 31 selects, every line time, one scanning signal line from among the scanning signal lines G1 to Gm according to a timing control signal C1, and applies a high-level voltage to the selected scanning signal line and applies a low-level voltage to the other scanning signal lines. The data signal line drive circuit 32 drives the data signal lines SR1 to SRn, SG1 to SGn, and SB1 to SBn by a line sequential system, based on display data DR, DG, and DB outputted from the display data processing unit 12. More specifically, the data signal line drive circuit 32 stores at least a portion of each of the display data DR, DC, and DB for one row and applies, every line time, voltages according to the portions of the display data for one row to the data signal lines SR1 to SRn, SG1 to SGn, and SB1 to SBn. Note that the data signal line drive circuit 32 may drive the data signal lines SR1 to SRn, SG1 to SGn, and SB1 to SBn by a dot sequential system.

During the sensing period, the sensor row drive circuit 33 and the sensor output amplifiers 34 operate. The sensor row drive circuit 33 selects, every line time, one each from the sensor read lines RW1 to RWm and the sensor reset lines RS1 to RSm according to a timing control signal C2, and applies a predetermined read voltage and a predetermined reset voltage to the selected sensor read line and sensor reset line, respectively, and applies a voltage different than those applied upon selection, to the other signal lines. Note that typically the length of one line time differs between the display period and the sensing period. The sensor output amplifiers 34 amplify voltages selected by their corresponding switches 37 and output the amplified voltages as sensor output signals SS1 to SSp.

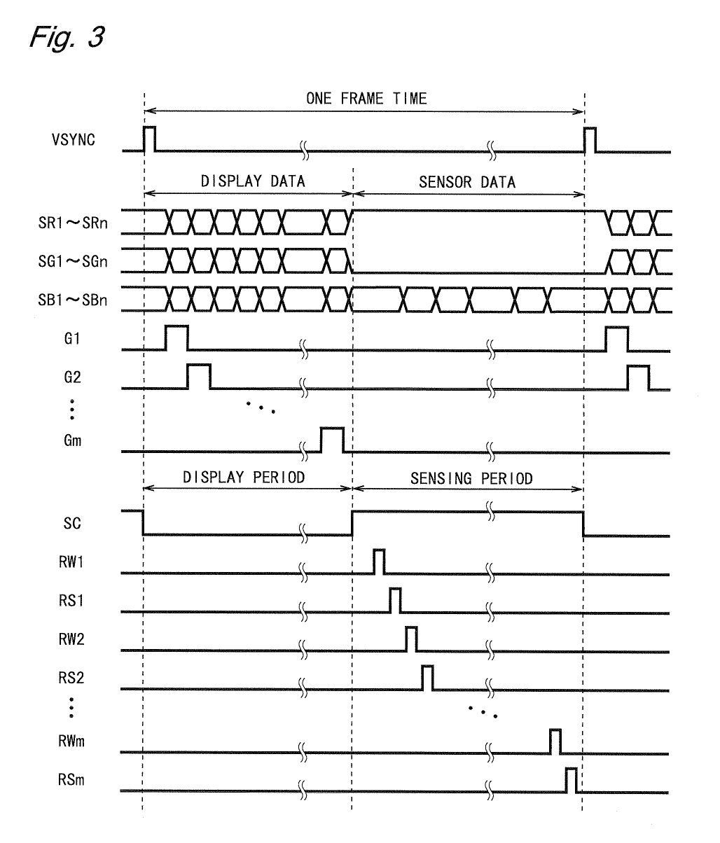

FIG. 3 is a timing chart for the liquid crystal display device 10. As shown in FIG. 3, a vertical synchronizing signal VSYNC goes to a high level every frame time. One frame time is divided into a display period and a sensing period. A sense signal SC is a signal indicating whether the period is the display period or the sensing period. The sense signal SC is at a low level during the display period and is at a high level during the sensing period.

During the display period, the switches 35 and 36 are placed in an on state and all the data signal lines SR1 to SRn, SG1 to SGn, and SB1 to SBn are connected to the data signal line drive circuit 32. During the display period, first, the voltage of the scanning signal line G1 goes to a high level. Then, the voltage of the scanning signal line G2 goes to a high level and thereafter the voltages of the scanning signal lines G3 to Gm go to a high level in turn. While the voltage of a scanning signal line G1 is at a high level, voltages to be written into 3n pixel circuits 1 connected to the scanning signal line G1 are applied to the data signal lines SR1 to SRn, SG1 to SGn, and SB1 to SBn.

During the sensing period, the switches 38 are placed in an on state and the switches 37 are placed in an on state in a time-division manner. Hence, a power supply voltage VDD is fixedly applied to the R data signal lines SR1 to SRn, and the B data signal lines SB1 to SBn are connected to the input terminals of the sensor output amplifiers 34 in a time-division manner. During the sensing period, first, the sensor read line RW1 and the sensor reset line RS1 are selected. Then, the sensor read line RW2 and the sensor reset line RS2 are selected and thereafter the sensor read lines RW3 to RWm and the sensor reset lines RS3 to RSm are selected in turn on a pair-by-pair basis. A read voltage and a reset voltage are applied to the selected sensor read line and sensor reset line, respectively. While a sensor read line RWi and a sensor reset line RSi are selected, voltages according to the amounts of light detected by respective n optical sensors 2 connected to the sensor read line RWi are outputted to the B data signal lines SB1 to SBn, respectively.

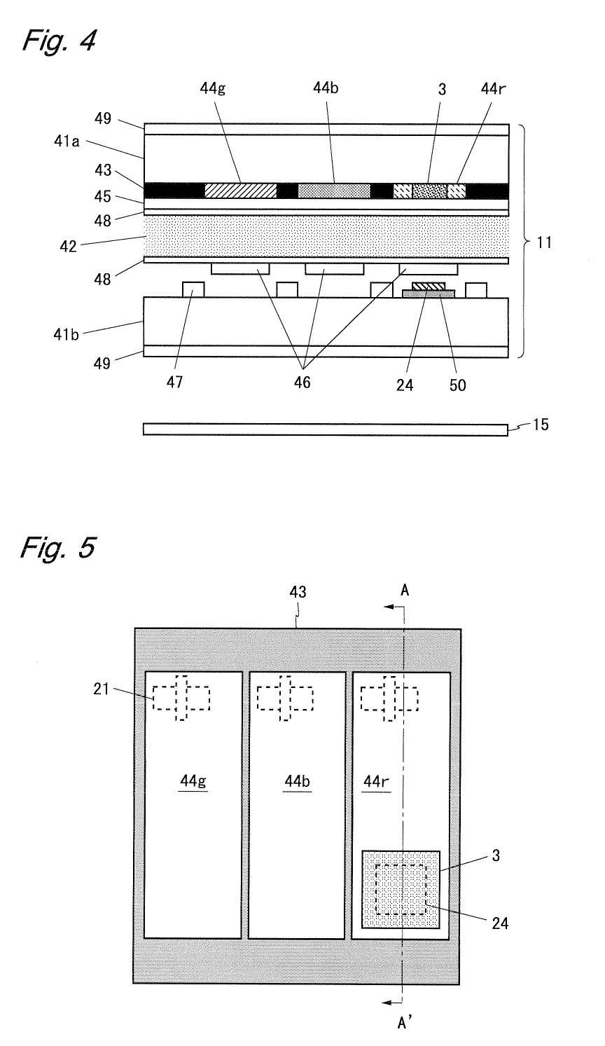

FIG. 4 is a view showing a cross section of the liquid crystal panel 11 and an arrangement position of the backlight 15. The liquid crystal panel 11 has a structure in which a liquid crystal layer 42 is sandwiched between two glass substrates 41a and 41b. One glass substrate 41a has a light-shielding film (black matrix) 43, color filters 44r, 44g, and 44b of three colors, a counter electrode 45, and the like, provided thereon. The other glass substrate 41b has pixel electrodes 46, data signal lines 47, optical sensors 2, and the like, provided thereon. Alignment films 48 are respectively provided on surfaces of the glass substrates 41a and 41b that face each other, and polarizing plates 49 are respectively provided on the other surfaces. Of the two surfaces of the liquid crystal panel 11, a surface on the side of the glass substrate 41a serves as the front surface and a surface on the side of the glass substrate 41b serves as the back surface. The backlight 15 is provided on the back surface side of the liquid crystal panel 11.

Infrared light transmitting filters 3 are resin filters which are the same as the color filters 44r, 44g, and 44b, and are formed in the color filters 44r, 44g, and 44b. Each red color filter 44r is provided with an opening and an infrared light transmitting filter 3 is provided in the opening. In this manner, the infrared light transmitting filter 3 is formed within the red color filter 44r. A photodiode 24 included in an optical sensor 2 is provided on the glass substrate 41b below the infrared light transmitting filter 3. A light-shielding layer 50 is provided between the photodiode 24 and the glass substrate 41b. The infrared light transmitting filter 3 thus provided in a path of light entering the optical sensor 2 prevents visible light from entering the optical sensor 2. Note that the light-shielding layer 50 is provided to prevent light emitted from the backlight 15 from directly affecting the operation of the photodiode 24.

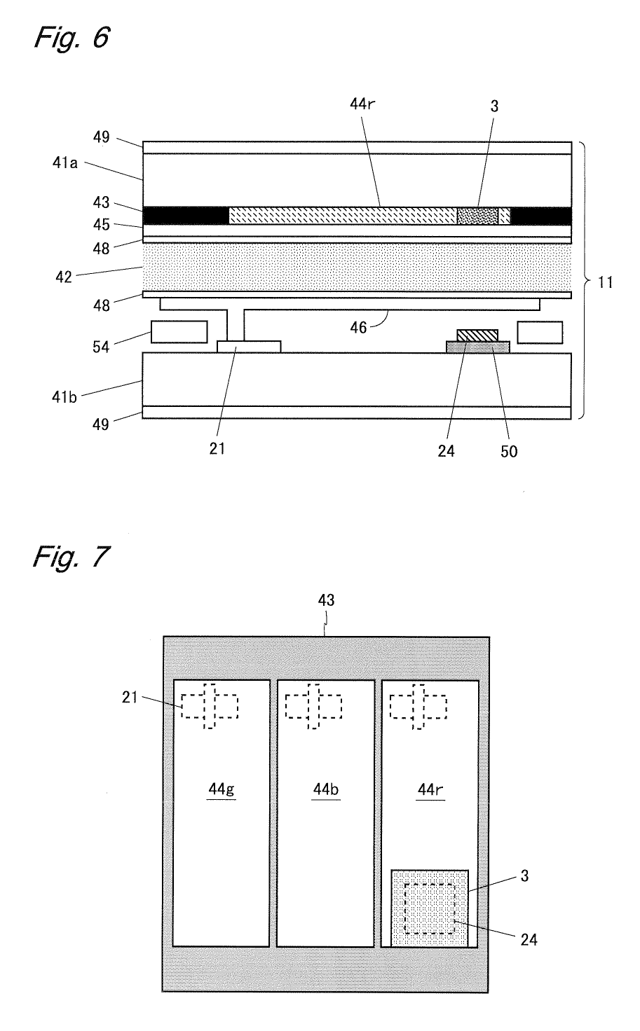

FIG. 5 is a layout diagram of the liquid crystal panel 11. As shown in FIG. 5, the light-shielding film 43 is provided with three openings per pixel and a TFT 21 is arranged below each opening. In the three openings, a green color filter 44g, a blue color filter 44b, and a red color filter 44r are provided in this order from the left. The red color filter 44r is provided with an opening and an infrared light transmitting filter 3 is provided in the opening. A photodiode 24 is arranged below the infrared light transmitting filter 3. FIG. 6 is an A-A′ cross-sectional view of FIG. 5. In FIG. 6, scanning signal lines 54 provided on the glass substrate 41b are also shown. Note that, as shown in FIG. 7, the infrared light transmitting filter 3 may be arranged in a position within the red color filter 44r and adjacent to the light-shielding film 43 (i.e., such that the layout positions of the infrared light transmitting filter 3 and the light-shielding film 43 are adjacent to each other).

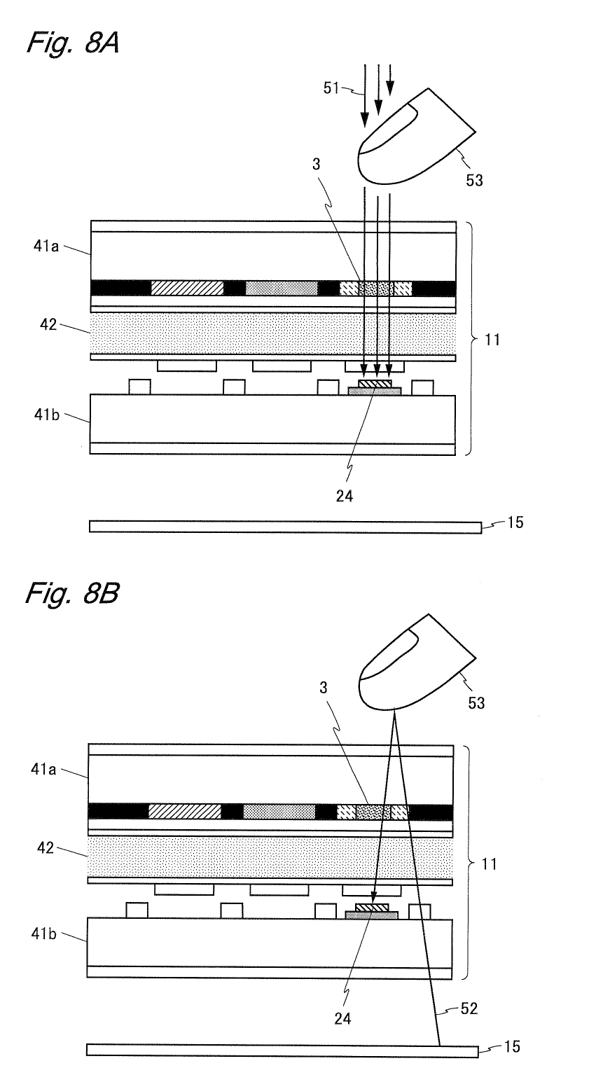

When the liquid crystal display device 10 detects a touch position on a display screen, the liquid crystal display device 10 uses either a method of detecting a shadow image or a method of detecting a reflection image (or both a shadow image and a reflection image). FIG. 8A is a diagram showing the principle of the method of detecting a shadow image and FIG. 8B is a diagram showing the principle of the method of detecting a reflection image. Note that the method of detecting a shadow image is used in an environment where outside light includes infrared light (e.g., the outdoors or when light of a halogen lamp is received).

In the method of detecting a shadow image (FIG. 8A), an optical sensor 2 including a photodiode 24 detects outside light 51 having passed through the glass substrate 41a, the liquid crystal layer 42, and the like. At this time, when an object 53 such as a finger is present in the vicinity of the front surface of the liquid crystal panel 11, the outside light 51 to enter the optical sensor 2 is blocked by the object 53. In addition, by the action of an infrared light transmitting filter 3, only infrared light included in the outside light 51 enters the optical sensor 2. Thus, using the optical sensor 2, a shadow image of the object 53 by the infrared light included in the outside light 51 can be detected.

In the method of detecting a reflection image (FIG. 8B), an optical sensor 2 including a photodiode 24 detects reflected light of backlight light 52. More specifically, the backlight light 52 emitted from the backlight 15 passes through and gets out of the liquid crystal panel 11 through the front surface of the liquid crystal panel 11. At this time, when an object 53 is present in the vicinity of the front surface of the liquid crystal panel 11, the backlight light 52 is reflected off the object 53. For example, the balls of human fingers reflect light well, including infrared light. The reflected light of the backlight light 52 passes through the glass substrate 41a, the liquid crystal layer 42, and the like, and enters the optical sensor 2. In addition, by the action of an infrared light transmitting filter 3, only infrared light included in the backlight light 52 enters the optical sensor 2. Thus, using the optical sensor 2, a reflection image of the object 53 by the infrared light included in the backlight light 52 can be detected.

By using the above-described two methods in combination, both a shadow image and a reflection image can be detected. That is, using the optical sensor 2, a shadow image of the object 53 by the infrared light included in the outside light 51 and a reflection image of the object 53 by the infrared light included in the backlight light 52 can be simultaneously detected.

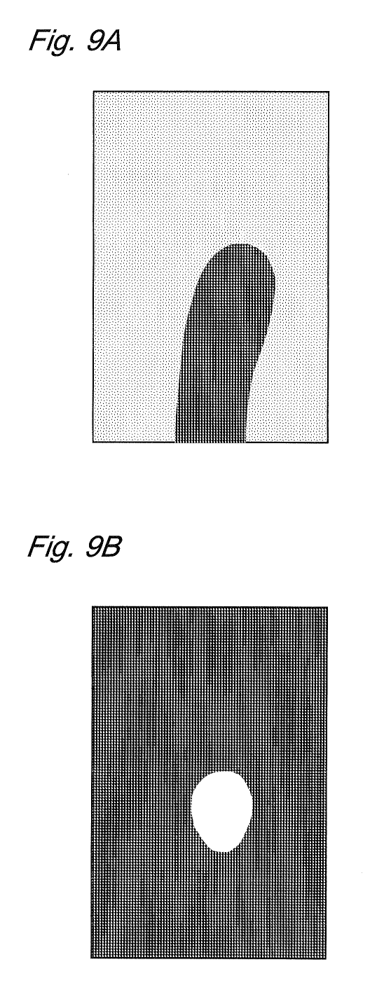

FIGS. 9A and 9B are views showing examples of a scanned image including a finger image. A scanned image shown in FIG. 9A is obtained in a state in which the backlight 15 is turned off when outside light includes infrared light, and includes a shadow image of a finger. A scanned image shown in FIG. 9B is obtained in a state in which the backlight 15 is turned on when outside light does not include infrared light, and includes a reflection image of the ball of a finger. The sensor data processing unit 14 performs an image recognition process on such scanned images and outputs coordinate data Co representing a touch position.

The effects of the liquid crystal display device 10 according to the present embodiment will be described below. As described above, a conventional display device with optical sensors that does not include infrared light transmitting filters has a problem that, since an image obtained by the optical sensors is influenced by outside light or backlight light (see FIG. 19), the detection accuracy for a touch position decreases.

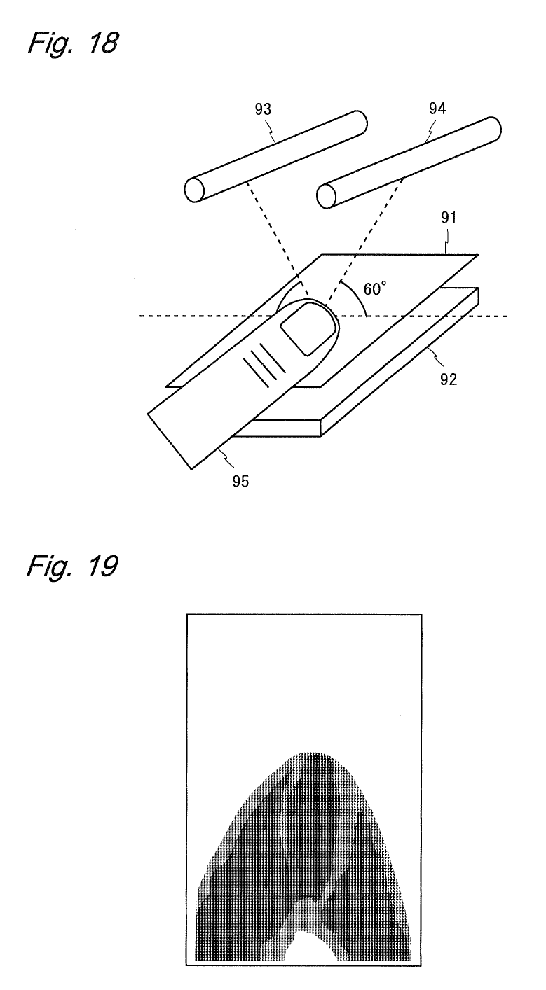

On the other hand, the liquid crystal display device 10 according to the present embodiment includes a plurality of pixel circuits 1 and a plurality of optical sensors 2 which are arranged two-dimensionally, and includes infrared light transmitting filters 3 respectively in paths of light entering the optical sensors 2. Since the infrared light transmitting filters 3 allow infrared light to pass therethrough and cut off visible light, infrared light enters the optical sensors 2 but visible light does not enter the optical sensors 2. Thus, a scanned image obtained by the optical sensors 2 is not influenced by visible light included in outside light which does not include infrared light (e.g., light from a fluorescent lamp and the like), or included in backlight light reflected off an object present in the vicinity of the display surface. For example, even in the liquid crystal display device 10 present in the operating environment shown in FIG. 18, a scanned image in which a finger can be easily recognized (see FIG. 9B) can be obtained. Thus, according to the liquid crystal display device 10 according to the present embodiment, a touch position can be detected with high accuracy, based on a scanned image that is not influenced by visible light included in a large amount in outside light or backlight light.

In addition, by using resin filters as the infrared light transmitting filters 3, filter portions that allow infrared light to pass therethrough and cut off visible light can be easily formed. In addition, by forming the infrared light transmitting filters 3 in the color filters 44, the configuration of the device can be simplified. In addition, the light reception sensitivity of the optical sensors 2 formed of CG silicon is lower for red light than for green light and blue light. Therefore, by forming each infrared light transmitting filter 3 within a red color filter 44r, even when visible light enters an optical sensor 2 in an oblique direction without passing through an infrared light transmitting filter 3, the influence of the entered visible light on a scanned image is reduced, enabling to detect a touch position with high accuracy. In particular, by arranging each infrared light transmitting filter 3 in a position within a red color filter 44r and adjacent to the light-shielding film 43, the influence of visible light having entered in an oblique direction exerted on a scanned image is further reduced, enabling to detect a touch position with higher accuracy.

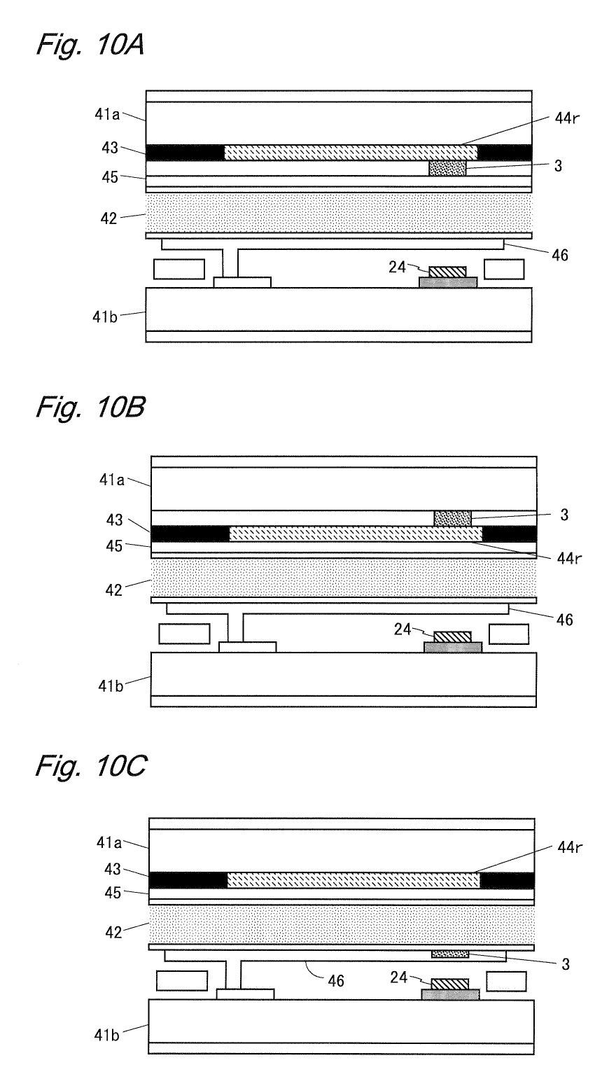

Note that although in the above description the infrared light transmitting filters 3 are formed in the color filters 44, instead of this, as shown in FIGS. 10A to 10C, the infrared light transmitting filters 3 may be formed separately from the color filters 44 and each infrared light transmitting filter 3 may be arranged in a position in which the infrared light transmitting filter 3 overlaps a red color filter 44r when viewed in a direction perpendicular to the infrared light transmitting filter 3. For example, infrared light transmitting filters 3 and color filters 44 may be formed separately and one each may be affixed together. When the two affixed filters are provided on the glass substrate 41a, the infrared light transmitting filter 3 may be arranged on the back surface side of the liquid crystal panel 11 (FIG. 10A) or the infrared light transmitting filter 3 may be arranged on the front surface side of the liquid crystal panel 11 (FIG. 10B). Alternatively, infrared light transmitting filters 3 and color filters 44 may be formed separately and the infrared light transmitting filters 3 may be provided on the glass substrate 41b having provided thereon TFTs 21 (FIG. 100). In these cases, too, each infrared light transmitting filter 3 may be arranged in a position in which the infrared light transmitting filter 3 overlaps a red color filter 44r when viewed in a direction perpendicular to the infrared light transmitting filter 3 and which is adjacent to the light-shielding film 43 (i.e., such that the layout positions of the infrared light transmitting filter 3 and the light-shielding film 43 are adjacent to each other).

By thus forming infrared light transmitting filters 3 and color filters 44 separately, the infrared light transmitting filters 3 can be implemented in various forms. In addition, by arranging each infrared light transmitting filter 3 in a position in which the infrared light transmitting filter 3 overlaps a red color filter 44r when viewed in a direction perpendicular to the infrared light transmitting filter 3, even when visible light enters an optical sensor 2 in an oblique direction without passing through an infrared light transmitting filter 3, the influence of the entered visible light on a scanned image is reduced, enabling to detect a touch position with high accuracy. In particular, by arranging each infrared light transmitting filter 3 in a position in which the infrared light transmitting filter 3 overlaps a red color filter 44r when viewed in a direction perpendicular to the infrared light transmitting filter 3 and which is adjacent to the light-shielding film 43, the influence of visible light having entered in an oblique direction exerted on a scanned image is further reduced, enabling to detect a touch position with higher accuracy.

If the infrared light transmitting filters 3 are provided for the purpose of allowing infrared light to pass therethrough and cutting off visible light, then the infrared light transmitting filters 3 do not necessarily need to completely cut off visible light and may allow visible light of, for example, the order of several tens of percent to pass therethrough. In addition, the infrared light transmitting filters 3 may allow not only infrared light but also such light other than visible light that has wavelengths on the long-wavelength side to pass therethrough.

### Second Embodiment

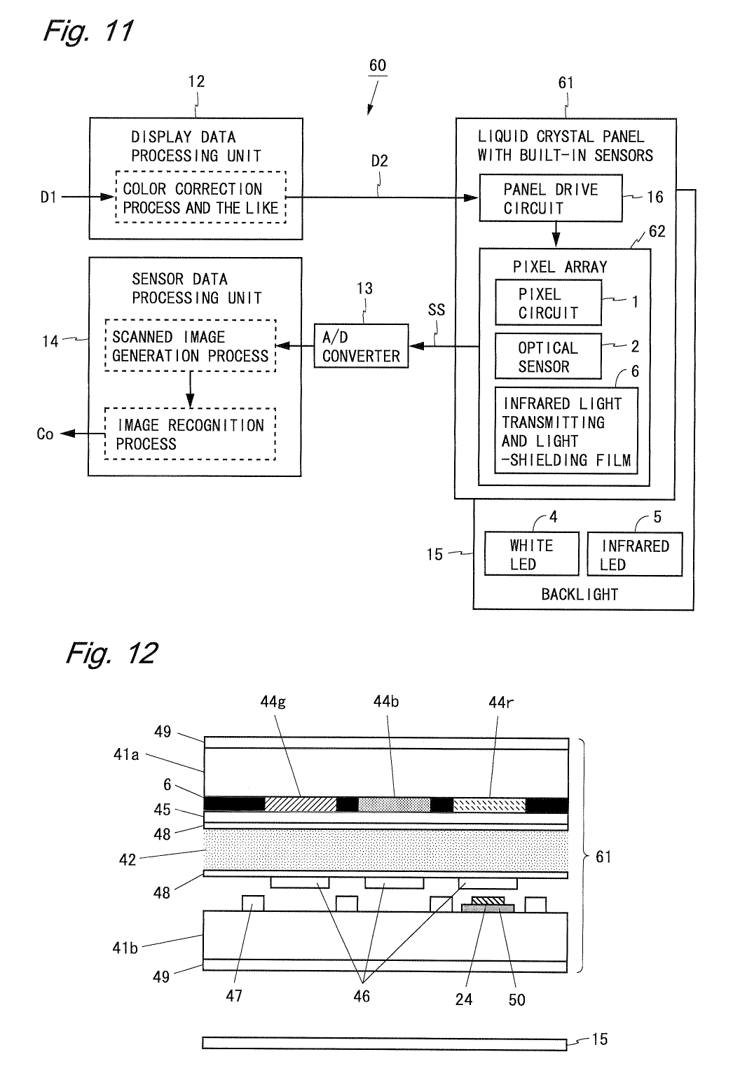

FIG. 11 is a block diagram showing a configuration of a liquid crystal display device according to a second embodiment of the present invention. A liquid crystal display device 60 shown in FIG. 11 is such that in the liquid crystal display device 10 according to the first embodiment the liquid crystal panel with built-in sensors 11 is replaced by a liquid crystal panel with built-in sensors 61. Of the components in the present embodiment, the same components as those in the first embodiment are denoted by the same reference numerals and description thereof is omitted.

The liquid crystal panel with built-in sensors 61 (hereinafter, referred to as the liquid crystal panel 61) includes a panel drive circuit 16 and a pixel array 62. The pixel array 62 includes a plurality of pixel circuits 1 and a plurality of optical sensors 2 which are arranged two-dimensionally. The pixel array 62 further includes an infrared light transmitting and light-shielding film 6 that allows infrared light to pass therethrough and cuts off (absorbs) visible light. The optical sensors 2 are arranged in a position in which the optical sensors 2 overlap the infrared light transmitting and light-shielding film 6 when viewed in a direction perpendicular to the pixel circuits 1. The infrared light transmitting and light-shielding film 6 is formed of, for example, a resin.

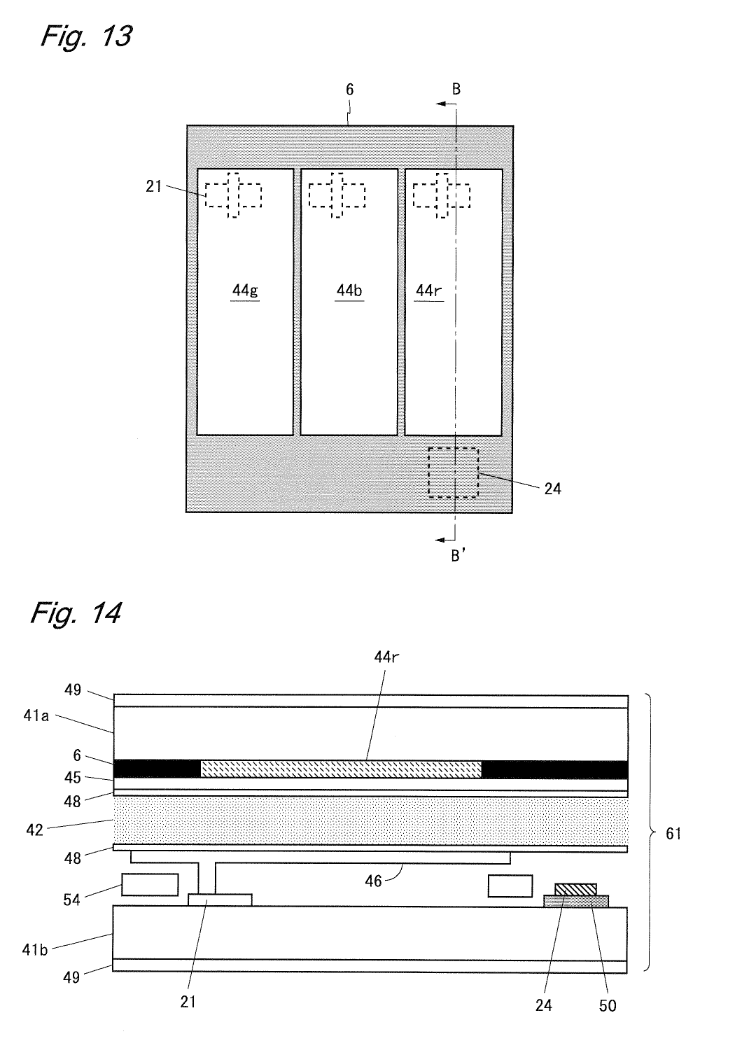

FIG. 12 is a view showing a cross section of the liquid crystal panel 61 and an arrangement position of a backlight 15. FIG. 13 is a layout diagram of the liquid crystal panel 61 and FIG. 14 is a B-B′ cross-sectional view of FIG. 13. As shown in FIGS. 12 to 14, the infrared light transmitting and light-shielding film 6 has openings for the respective pixel circuits 1, and a photodiode 24 included in each optical sensor 2 is arranged in a position in which the photodiode 24 overlaps the infrared light transmitting and light-shielding film 6 when viewed in a direction perpendicular to the pixel circuits 1. In this example, the photodiode 24 is provided on a glass substrate 41b near below a red color filter 44r. The infrared light transmitting and light-shielding film 6 thus provided in paths of light entering the optical sensors 2 prevents visible light from entering the optical sensors 2, as with the infrared light transmitting filters 3 according to the first embodiment.

According to the liquid crystal display device 60 according to the present embodiment, as with the first embodiment, a touch position can be detected with high accuracy, based on an image that is not influenced by visible light included in a large amount in outside light or backlight light. In addition, by forming, by a light-shielding film, a filter portion that allows infrared light to pass therethrough and cuts off visible light, the configuration of the device can be simplified and the aperture ratio can be increased.

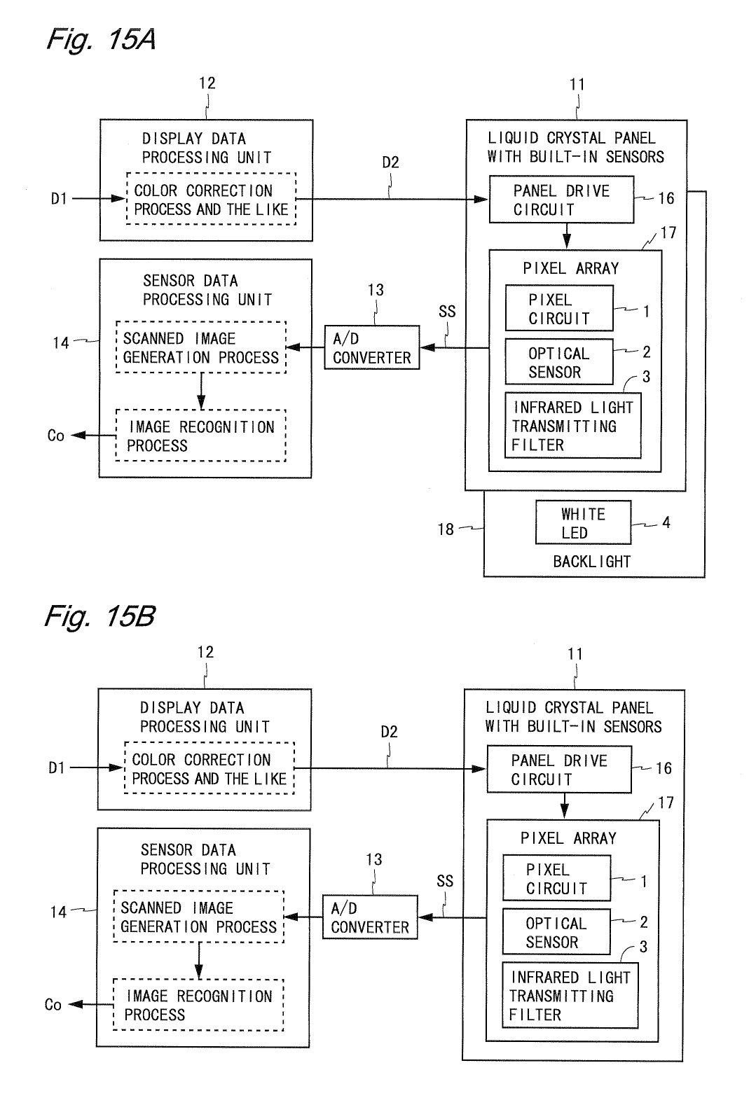

Note that although liquid crystal display devices according to the first and second embodiments include a backlight 15 including white LEDs 4 and infrared LEDs 5, a liquid crystal display device of the present invention may include any type of backlight or may not include a backlight. FIGS. 15A and 15B are block diagrams showing configurations of liquid crystal display devices according to variants of the present invention. A liquid crystal display device shown in FIG. 15A includes, instead of the backlight 15, a backlight 18 including only white LEDs 4 as light sources. A liquid crystal display device shown in FIG. 15B does not include a backlight. In addition, liquid crystal display devices including an infrared light transmitting and light-shielding film 6 can also be configured by the same methods as above.

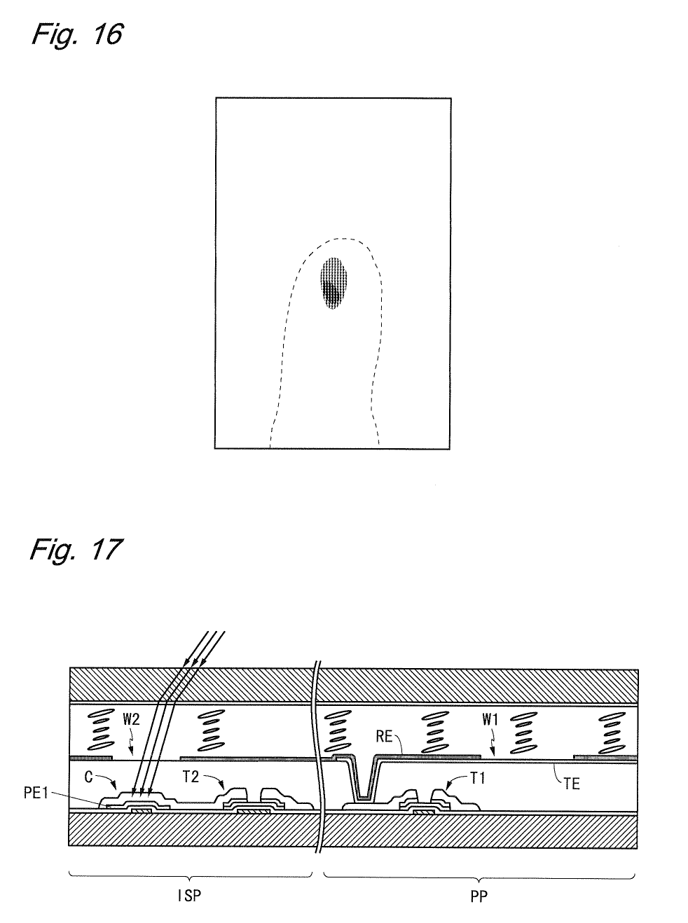

Such liquid crystal display devices with optical sensors that do not have the function of emitting infrared light detect a touch position using the method of detecting a shadow image, in an environment where outside light includes infrared light. When a conventional liquid crystal display device that does not include infrared light transmitting filters is caused to operate outdoors, a scanned image shown in FIG. 16, for example, is obtained. In the scanned image shown in FIG. 16, a shadow image of the base side of a finger has disappeared by sunlight and only a shadow image of a fingertip remains. Note that an outline of the finger indicated by a dashed line in FIG. 16 is shown for reference and thus is not included in the actual scanned image.

On the other hand, when a liquid crystal display device of the present invention that includes infrared light transmitting filters is caused to operate outdoors, a scanned image shown in FIG. 9A, for example, is obtained. In the scanned image shown in FIG. 9A, a shadow image of the base side of a finger appears clearly. Since infrared light is longer in wavelength than visible light and thus is difficult to be diffused in the air, by arranging each infrared light transmitting filter above an optical sensor, a shadow image of a finger becomes clear. Accordingly, even in a liquid crystal display device with optical sensors that does not have the function of emitting infrared light, by arranging each infrared light transmitting filter above an optical sensor, a shadow image of a finger is made clear, enabling to increase the detection accuracy for a touch position.

Although a liquid crystal display device according to the first embodiment includes infrared light transmitting filters 3 made of a resin and a liquid crystal display device according to the second embodiment includes an infrared light transmitting and light-shielding film 6 formed of a resin and the like, a liquid crystal display device of the present invention may include any filter portion that allows infrared light to pass therethrough and cuts off visible light, in paths of light entering optical sensors 2. For example, a liquid crystal display device of the present invention may include, instead of the infrared light transmitting filters 3, polarizing filters that polarize entered light in a direction orthogonal to a polarization axis of a polarizing plate 49 which is provided on a glass substrate 41a on the side of color filters 44 (a polarizing plate provided on the display surface side of a liquid crystal panel). By using filter portions having the function of polarizing entered light in the above-described manner, the filter portions that allow infrared light to pass therethrough and cut off visible light can be easily formed.

As described above, according to a liquid crystal display device of the present invention, by arranging each infrared light transmitting filter above an optical sensor, an image obtained by the optical sensors is prevented from being influenced by visible light included in outside light or backlight light, and thus, a touch position can be detected with high accuracy, based on an image that is not influenced by visible light included in a large amount in outside light or backlight light. Note that display devices other than liquid crystal display devices can also be configured by the above-described methods.

### INDUSTRIAL APPLICABILITY

Display devices with optical sensors of the present invention have a feature that the display devices can detect a touch position with high accuracy without being influenced by outside light or backlight light, and thus, can be used as various display devices such as liquid crystal display devices.

1. A display device including a plurality of optical sensors, the display device comprising:
a plurality of pixel circuits arranged two-dimensionally;
a plurality of optical sensors arranged two-dimensionally in a same plane as the pixel circuits; and
a filter portion that is respectively provided in path of light entering the optical sensor and that allows infrared light to pass therethrough and cuts off visible light.

2. The display device according to claim 1, further comprising a color filter of a plurality of colors, wherein
the pixel circuits and the optical sensors are formed of polysilicon, and
the filter portion is formed within a red color filter of the color filter.

3. The display device according to claim 2, further comprising a light-shielding film having openings for the respective pixel circuits, wherein
the filter portion is arranged in a position within the red color filter and adjacent to the light-shielding film.

4. The display device according to claim 1, further comprising a color filter of a plurality of colors, wherein
the pixel circuits and the optical sensors are formed of polysilicon, and
the filter portions is formed separately from the color filter and is arranged in a position in which the filter portion overlaps a red color filter of the color filter when viewed in a direction perpendicular to the filter portion.

5. The display device according to claim 4, further comprising a light-shielding film having openings for the respective pixel circuits, wherein
the filter portion is arranged in a position in which the filter portion overlaps the red color filter when viewed in the direction perpendicular to the filter portion and which is adjacent to the light-shielding film.

6. The display device according to claim 1, wherein the filter portion is a resin filter.

7. The display device according to claim 1, wherein the filter portions has a function of polarizing entered light.

8. The display device according to claim 1, wherein
a light-shielding film having openings for the respective pixel circuits is provided as the filter portion, and
the optical sensor is arranged in a position in which the optical sensor overlaps the light-shielding film when viewed in a direction perpendicular to the pixel circuits.
